(19) United States
(12) Patent Application Publication
(10) Pub. No.: US 2008/0147855 A1
(43) Pub. Date: Jun. 19, 2008

(54) Method and server for detecting condition of network communication

(75) Inventors: Quan Qi, Shenzhen (CN); Qian Liu, Shenzhen (CN); Jieping Zhong, Shenzhen (CN); Jingmin Jiao, Shenzhen (CN)

Correspondence Address: LADAS & PARRY LLP, 26 WEST 61ST STREET, NEW YORK, NY, 10023, US

(73) Assignee: HUAWEI TECHNOLOGIES CO., LTD.

(21) Appl. No.: 12/011,611

(22) Filed: Jan. 28, 2008

Related U.S. Application Data
(63) Continuation of application No. PCT/CN2006/001283, filed on Jun. 12, 2006.

(30) Foreign Application Priority Data
Aug. 9, 2005 (CN) 200510089997.3

(51) Int. Cl. G06F 15/173

(52) U.S. Cl. 709/224; 709/223

(57) ABSTRACT

The present invention discloses two methods and two servers thereof for detecting condition of network communication. The first method includes: receiving a detecting request for obtaining the condition of network communication between a source client and a destination client; sending the detecting request to the destination client and receiving a detecting response returned from the destination client; returning the detecting response to the source client according to route information of the source client. The second method includes: receiving a detecting request for obtaining the condition of network communication between the source client and a destination client; obtaining the condition of network communication between the server and the corresponding destination client after receiving the detecting request from the source client; and returning the detecting response to the source client. Furthermore, the present invention further provides a procedure of detecting a communication time.

The present application is a continuation application of PCT application No. PCT/CN2006/001283, filed Jun. 12, 2006, which claims the Chinese priority No. 200510089997.3, filed Aug. 9, 2005.

### FIELD OF THE INVENTION

The present invention relates to network detecting techniques, particularly to a method and a server for detecting condition of network communication.

### BACKGROUND OF THE INVENTION

When a game user is playing online game involving multiple players, he/she often wants to know the condition of network communication between his/her client and the clients of other parties. For example, when a game user in an online game doesn't get any response from another game player after waiting for a long time, he/she usually wants to know whether that player is still online and, if that player is online, information of the connective speed of the network between his/her client and the client of that player, so as to control the decision making for the game. In addition, in an online answering question that involves multiple players, in some cases, the tester wants to know the response speed of the testees. In those cases, the tester usually takes the following method: the tester records a time at which a question is sent to a testee and a time at which the answer is received from the testee; then, the tester calculates the difference between those times, and measures the response speed of the testee directly with the calculation result. However, due to the complexity of the testee's network environment, the duration for answering the question by the testee will be affected by the network condition inevitably. For example, if the network speed of testee A is relatively low, in one aspect, the transmission of the question to the testee A will take a long time, and, as a result, there is a delay for testee A to receive the question; in the other aspect, the transmission of the answer from the terminal of testee A to the tester will correspondingly take a long time, and, as the result, there is a delay for the tester to receive the answer. The above two delays will together result in that the difference in time calculated by the tester is relatively large, and therefore the tester will make a conclusion that the response speed of the testee A is relatively low. Apparently, if the tester does not know the network condition of a testee, the tester will not get an accurate result of response speed of the testee.

It can be seen from the above example that it is necessary and important to obtain the condition of network communication in real time. However, no corresponding solution for the above problem is available by now.

### SUMMARY OF THE INVENTION

In view of the above problem, the object of the present invention is to provide two methods and a server for detecting condition of network communication, to enable a client connected to the server to detect the condition of network communication between itself and a destination client.

A method for detecting condition of network communication is provided according to the present invention, the network at least including a server and more than one client connected to the server. In the method, route information of all clients is stored in the server in advance. The process in which the condition of network communication is detected includes the following process:

a. sending, by a source client, a detecting request to the server for obtaining the condition of network communication between the source client and a destination client;

b. sending, by the server, a detecting request to the destination client according to the route information of the destination client stored in the server after the server receives the detecting request; returning, by the destination client, a detecting response to the server after the destination client receives the detecting request;

c. returning, by the server, a detecting response to the source client according to the route information of the source client stored in the server after the server receives the detecting response; obtaining, by the source client, the condition of network communication between the source client and the destination client according to the received detecting response.

In the process ‘a’ of the method, the source client sends the detecting request in the manner that the source client sends the detecting request carrying a destination client identity to the server.

The process ‘b’ further includes: obtaining, by the server, the destination client identity carried in the received detecting request from the received detecting request, and searching for the route information corresponding to the destination client identity in the route information of clients stored in the server, and executing the procedure of sending the detecting request to the destination client in process ‘b’.

In process ‘b’, the destination client returns the detecting response to the server in the manner that the destination client returns a detecting response carrying an identity of source client that initiated the detecting request to the server.

The process ‘c’ further includes: obtaining, by the server, the source client identity carried in the received detecting response, and searching for the route information corresponding to the source client identity from the client route information stored in the server, and executing the procedure of returning the detecting response to the source client in process ‘c’.

In process ‘b’ of the above method, the procedure that the server sends the detecting request to the destination client includes: replacing, by the server, the destination client identity in the received detecting request by the identity of the source client that sends the detecting request, generating a new detecting request and sending the request to the destination client; the procedure that the destination client returns the detecting response to the server includes: obtaining, by the destination client, the source client identity carried in the received detecting request, generating a detecting response containing the source client identity and returning the detecting response to the server.

In process ‘c’, the procedure that the server returns a detecting response to the source client includes: replacing, by the server, the source client identity in the received detecting response by the identity of destination client that sent the response, generating a new detecting response and returning the detecting response to the source client.

In process ‘c’, the procedure of obtaining the condition of network communication according to the detecting response includes: obtaining, by the source client, the destination client identity carried in the response, and determining that the network between the source client and the destination client is still in “Connected” state when the source client receives the detecting response returned from the server.

In process ‘a’ of the above method, the detecting request further contains the source client identity.

In process ‘b’, the procedure that the server sends the detecting request to the destination client includes: forwarding, by the server, the detecting request received from the source client to the destination client; the procedure that the destination client returns a detecting response to the server includes: obtaining, by the destination client, the source client identity and the destination client identity carried in the received detecting request, generating a detecting response containing the source client identity and the destination client identity and returning the detecting response to the server.

In process ‘c’, the procedure that the server returns a detecting response to the source client includes: forwarding, by the server, the detecting response received from the destination client to the source client; the procedure of obtaining the condition of network communication according to the detecting response includes: obtaining, by the source client, the destination client identity carried in the detecting response, and determining the network between the source client and the destination client is still in “Connected” state when the source client receives the detecting response returned from the server.

In the above method, the process ‘a’ further includes: obtaining, by the source client, a system time t1 at which the detecting request is sent to the server, and further comprising, in the detecting request, a TimeStamp recording the system time t1.

In process ‘b’, the procedure that the destination client returns a detecting response to the server further includes: obtaining, by the destination client, the TimeStamp carried in the received detecting request, and including the TimeStamp in the detecting response sent to the server.

In process ‘c’, the procedure of obtaining the condition of network communication according to the detecting response further includes: recording, by the source client, a system time t2 at which the detecting response is received, obtaining the system time t1 recorded in the TimeStamp from the received detecting response, and calculating the difference between the system time t2 and the system time t1 to obtain a communication time between the source client and the corresponding destination client.

In process ‘a’ of the above method, the detecting request further includes a Sequence identification (SequenceID) of this detecting request; and the process ‘a’ further includes: obtaining, by the source client, the system time t1 at which the detecting request is sent to the server, and storing the SequenceID of the detecting request together with the system time t1 in a corresponding way.

In process ‘b’, the procedure that the destination client returns the detecting response to the server further includes: obtaining, by the destination client, the SequenceID carried in the received detecting request, and including the SequenceID in the detecting response sent to the server.

In process ‘c’, the procedure of obtaining the condition of network communication according to the detecting response further includes: when receiving the detecting response returned from the server, recording, by the source client, the system time t2 at which the detecting response is received, obtaining the SequenceID carried in the response, searching for the system time t1 stored in the source client corresponding to this SequenceID, and calculating the difference between system time t2 and system time t1 to obtain the communication time between the source client and the corresponding destination client.

In the above method, the process ‘b’ further includes: returning, by the server, a receiving response to the source client, when the server receives the detecting request from the source client; obtaining, by the source client, the condition of network communication between the source client and the server according to the received receiving response.

In process ‘b’ of the above method, the procedure that the source client obtains the condition of network communication between the source client and the server according to the received receiving response includes: determining, by the source client, that the network between the source client and the server is in “Connected” state when the source client receives the receiving response returned from the server.

In the above method, the process ‘a’ further includes: obtaining, by the source client, the system time t1 at which the detecting request is sent to the server, and the detecting request further includes a TimeStamp recording the system time t1.

In process ‘b’, the procedure that the server returns a receiving response to the source client includes: obtaining, by the server, the TimeStamp carried in the received detecting request, and then returning a receiving response carrying the TimeStamp to the source client; the procedure that the source client obtains the condition of network communication according to the receiving response includes: obtaining, by the source client, a system time t3 at which the receiving response is received, obtaining the system time t1 recorded in the TimeStamp from the received receiving response, and calculating a difference between system time t3 and system time t1 to obtain the communication time between the source client and the server.

In the above method, in process ‘a’, the detecting request further includes the SequenceID of the detecting request; the process ‘a’ further includes: obtaining, by the source client, the system time t1 at which the detecting request is sent to the server, and storing the SequenceID of the detecting request together with the system time t1 in a corresponding way.

The process ‘b’ further includes: after receiving the detecting request from the source client, obtaining, by the server, the SequenceID carried in the detecting request, and then returning a receiving response carrying the SequenceID to the source client; the procedure that the source client obtains the condition of network communication according to the receiving response includes: recording, by the source client, the system time t3 at which the receiving response is received, obtaining the SequenceID carried in the received receiving response, and searching for the system time t1 stored in the source client corresponding to the SequenceID, and then calculating the difference between system time t3 and system time t1 to obtain the communication time between the source and the server.

In another aspect, the present invention provides a server, which is connected with more than one client, and is adapted to store route information of all clients; the server receives a detecting request from a source client for obtaining condition of network communication between the source client and a destination client and sends a detecting request to the destination client according to the route information of the destination client stored in the server; the server further receives a detecting response returned from the destination client, and returns a detecting response to the source client according to the route information of the source client stored in the server.

In the server described above, the detecting request carries a destination client identity and the detecting response carries a source client identity.

The server is adapted to obtain the destination client identity carried in the received detecting request and search for the route information corresponding to the destination client identity in the client route information stored in the server; and, the server is further adapted to obtain the source client identity carried in the received detecting response and search for the route information corresponding to the source client identity in the client route information stored in the server.

In the server described above, the server is adapted to replace the destination client identity in the received detecting request by the identity of the source client that sends this detecting request, generate a new detecting request and send the detecting request to the destination client; and, the server is further adapted to replace the source client identity in the received detecting response by the identity of the destination client that sends this detecting response, and generate a new detecting response and return the detecting response to the source client.

In the server described above, the detecting request further includes the source client identity and the detecting response further includes the destination client identity.

The server is adapted to forward the detecting request received from the source client to the destination client and forward the detecting response received from the destination client to the source client.

In the server described above, the server is further adapted to return a receiving response to the source client when it receives the detecting request from the source client.

In the server described above, the detecting request further includes a TimeStamp recording a system time t1.

The server is adapted to obtain the TimeStamp carried in the received detecting request, and return the receiving response carrying the TimeStamp to the source client.

In the server described above, the detecting request further includes a SequenceID.

The server is adapted to receive the detecting request from the source client, obtain the SequenceID carried in the detecting request, and return a receiving response carrying the SequenceID to the source client.

The present invention further provides another method for detecting condition of network communication, in which the network includes at least a server and more than one client connected with the server; the server obtains and stores the condition of network communication between the server and each of the clients; and the process of detecting the condition of network communication includes the following processes:

A. sending, by a source client, a detecting request for obtaining the condition of network communication between the source client and a destination client, to the server.

B. obtaining, by the server, the condition of network communication between the server and the corresponding destination client after receiving the detecting request from the source client; and returning, by the server, a detecting response to the source client according to the obtained condition of network communication to the source client.

C. obtaining, by the source client, the condition of network communication between the source client and the destination client according to the received detecting response.

In process ‘A’ of above method, the source client sends the detecting request in the manner that the source client sends a detecting request carrying a destination client identity to the server.

In process ‘B’, the server obtains the condition of network communication between the server and the destination client in the manner that the server obtains the destination client identity carried in the received detecting request, and then searches for the condition of network communication corresponding to the destination client identity stored in the server.

In the above method, the server obtains the condition of network communication between the server and each of the clients in the manner that the server stores route information of all clients in advance, and then sends the detecting request to each of the clients in a preset interval according to the route information stored in the server, and obtains the condition of network communication between the server and the corresponding client according to the detecting response returned from the client.

In process ‘B’ of the above method, the procedure of returning the detecting response to the source client includes: directly returning, by the server, the detecting response containing the condition of network communication between the server and the corresponding destination client to the source client.

The process ‘C’ includes: determining, by the source client, that the network between the source client and the destination client is in “Connected” state, after the source client receives the detecting response and determines, according to the condition of network communication carried in the response, that the network between the server and the destination client is in “Connected” state; otherwise determining that the network between the source and the destination client is in “Disconnected” state.

In the above method, the procedure that the server obtains and stores the condition of network communication between the server and each of the clients further includes: obtaining and storing, by the server, the communication time between the server and each of the clients.

In process ‘B’, the procedure that the server obtains the condition of network communication further includes: searching for, by the server, a stored communication time T1 between the server and the client that corresponds to the destination client identity carried in the detecting request and a communication time T2 between the server and the source client; the procedure of returning the detecting response to the source client further includes: including the communication times T1 and T2 in the detecting response returned to the source client.

The process ‘C’ further includes: calculating, by the source client, the sum of the communication times T1 and T2 to obtain the communication time between the source client and the destination client, when the source client receives the detecting response.

In the above method, the procedure that the server obtains and stores the condition of network communication between the server and each of the clients further includes: obtaining and storing, by the server, the communication time between the server and each of the clients.

In process ‘B’, the procedure that the server obtains the condition of network communication further includes: searching for, by the server, the stored communication time T1 between the server and the client that corresponds to the destination client identity carried in the detecting request and the communication time T2 between the server and the source client, and calculating the sum of communication times T1 and T2 found by the server; then including the calculation result in the detecting response returned to the source client.

The process ‘C’ further includes: obtaining, by the source client, the calculation result from the received detecting response to obtain the communication time between the source client and the destination client.

In the above method, the server obtains the communication time between the server and each of the clients in the manner that the server stores route information of all clients in advance, and then sends a detecting request to each of the clients in a preset interval according to the route information stored in the server, and includes, in the detecting request, the system time t1 at which the detecting request is sent; when receiving a detecting response carrying the system time t1 from the client, the server records the system time t2 at which the detecting response is received, and obtains the system time t1 from the received detecting response; then, the server calculates the difference between system time t2 and system time t1 to obtain the communication time between the server and the corresponding client; or,

the server stores the system time t1 at which the detecting request is sent and then records the system time t2 at which the detecting response is received after receiving the detecting response carrying the system time t1 returned from the client, and obtains the system time t1 from the detecting response; then, the server calculates the difference between system time t2 and system time t1 to obtain the communication time between the server and the corresponding client.

In another aspect, the present invention provides a server, which is adapted to obtain and store condition of network communication between the server and each of the clients, and receive a detecting request from a source client, obtain the condition of network communication between the server and the corresponding destination client, and return a detecting response to the source client according to the obtained condition of network communication.

In the server described above, the server is adapted to obtain a destination client identity carried in the received detecting request, and search for the condition of network communication corresponding to the destination client identity stored in the server.

In the server described above, the server is adapted to store route information of all clients in advance, and then send a detecting request to each of the clients in a preset interval according to the route information stored in the server, and obtain the condition of network communication between the server and the corresponding client according to the detecting response returned from the client.

In the server described above, the server is further adapted to obtain and store a communication time between the server and each of the clients, search for a stored communication time T1 between the server and the client corresponding to the destination client identity carried in the detecting request and a communication time T2 between the server and the source client, and include the communication times T1 and T2 in the detecting response returned to the source client.

In the server described above, the server is further adapted to obtain and store the communication time between the server and each of the clients, search for the stored communication time T1 between the server and the client corresponding to the destination client identity carried in the detecting request and the communication time T2 between the server and the source client, and calculate the sum of communication times T1 and T2, and then include the calculation result in the detecting response returned to the source client.

In the server described above, the server is adapted to store the route information of all clients in advance, and then send the detecting request to each of the clients in a preset interval according to the route information stored in the server, and include, in the detecting request, a system time t1 at which the detecting request is sent; when receiving a detecting response carrying the system time t1 from the client, the server records a system time t2 at which the detecting response is received, and obtains the system time t1 from the received detecting response; then, the server calculates the difference between system time t2 and system time t1 to obtain the communication time between the server and the corresponding client; or

the server is adapted to store the system time t1 at which the detecting request is sent and then records the system time t2 at which the detecting response is received after receiving the detecting response carrying the system time t1 returned from the client, and obtain the system time t1 from the detecting response; then, the server calculates the difference between system time t2 and system time t1 to obtain the communication time between the server and the corresponding client.

In conclusion, on the basis of a network structure that includes a server and more than one client connected to the server, the present invention provides two methods for detecting the condition of network communication. One of the methods is that the server stores route information of all clients in advance and sends a detecting request to a destination client when the server receives a detecting request from a source client. When receiving a detecting response from the destination client, the server returns a detecting response to the source client; then, the source client obtains condition of network communication between the source client and the destination client according to the received detecting response. In that way, the object of enabling the source client to detect the condition of network communication between the source client and the destination client is achieved.

In the above detecting method, the server interacts with the destination client after it receives the detecting request from the source client, so the above method is a passive method for obtaining the condition of network communication. Alternatively, the present invention can also employ a proactive method for obtaining the condition of network communication, i.e., the other method for detecting the condition of network communication, which is: the server interacts with the destination client actively in advance to obtain and store the condition of network communication between the server and the destination client; when receiving a detecting request from the source client, the server directly returns a detecting response to the source client according to the condition of network communication, which is stored in the server, between the server and the destination client; in that way, the object of enabling the source client to detect the condition of network communication between the source client and the destination client can also be achieved.

Furthermore, on the basis of above two methods, the present invention provides not only a procedure to enable the source client to detect whether the network between the source client and the destination client is in “Connected” state, but also a procedure of detecting the communication time and a procedure in which the source client detects the condition of network communication between the source client and the server; therefore, the present invention further enriches content of the condition of network communication that can be detected, and practically attains the object of detecting the condition of network communication.

### BRIEF DESCRIPTION OF THE DRAWINGS

FIG. 1 is a schematic diagram of a network structure to which the methods provided in the present invention apply;

FIG. 2 is a flow chart of a method for detecting condition of network communication according to a first embodiment of the present invention;

FIG. 3 is a flow chart of a method for detecting condition of network communication according to a second embodiment of the present invention;

FIG. 4 is a flow chart of a method for detecting condition of network communication according to a third embodiment of the present invention;

FIG. 5 is a flow chart of a method for detecting condition of network communication according to a fourth embodiment of the present invention;

FIG. 6 is a flow chart of a method for detecting condition of network communication according to a fifth embodiment of the present invention.

### DETAILED DESCRIPTION OF THE EMBODIMENTS

To make the object, technical scheme and advantages of the present invention more clear, further detailed description of the present invention will be given with reference to the accompanying drawings.

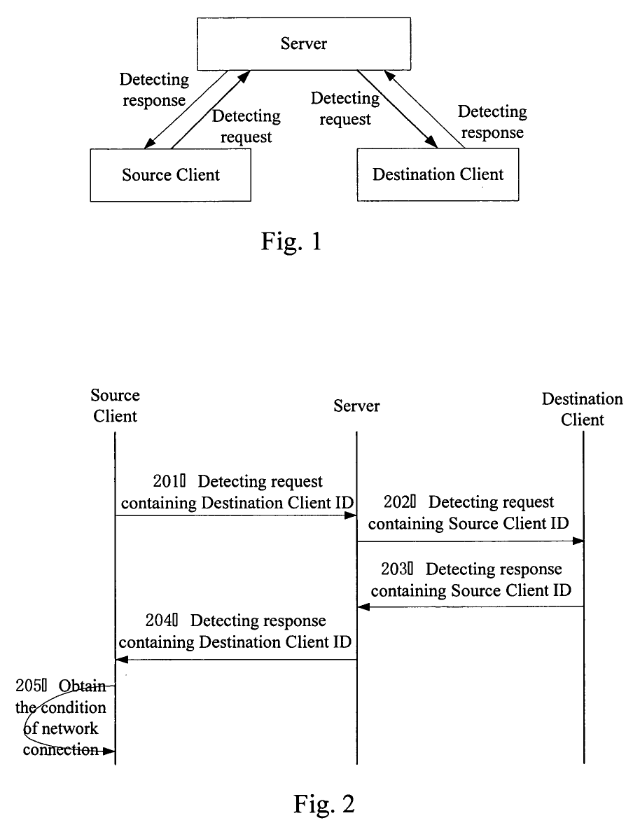

The present invention provides two methods for detecting the condition of network communication, which are applicable to the network structure shown in FIG. 1, i.e., the network includes at least a server and more than one client connected to the server. The conditions of network communication detected according to the method of the present invention may include: Connected/Disconnected state; or, the communication time if above network is in Connected state.

A method for detecting condition of network communication in the present invention is as follows: the server stores route information of all clients in advance; when receiving a detecting request (NetDetectReq) sent from a source client to obtain the condition of network communication between the source client and a destination client, the server obtains the route information of the destination client stored in the server, and then sends a detecting request containing information of the source client to the destination client according to the route information. When receiving the detecting request, the destination client returns a detecting response (NetDetectResp) containing the information of the source client to the server. And when receiving the detecting response, the server obtains the route information of the source client stored in the server, and returns a detecting response to the source client according to the route information. The source client obtains the condition of network communication between the source client and the destination client according to the received detecting response. It can be seen from the above process that the server interacts with the destination client after it receives the detecting request from the source client, so the above method is a passive method for detecting the condition of network communication.

In addition, on the basis of above method, the present invention further provides a server, which is connected to more than one client, and is adapted to store route information of all clients. The server receives a detecting request from a source client for obtaining the condition of network communication between the source client and a destination client and sends a detecting request to the destination client according to the route information of the destination client stored in the server. In addition, the server receives a detecting response returned from the destination client and returns a detecting response to the source client according to the route information of the source client stored in the server.

If the above detecting request carries the destination client identity and the detecting response carries the source client identity, the server obtains the destination client identity carried in the received detecting request, searches for the route information corresponding to the destination client identity from the client route information stored in the server; and the server also obtains the source client identity carried in the received detecting response and searches for the route information corresponding to the source client identity from the client route information stored in the server.

The server is further adapted to replace the destination client identity in the received detecting request by the identity of the source client that sent the detecting request, generate a new detecting request and send the detecting request to the destination client; and, replace the source client identity in the received detecting response by the identity of the destination client that sent the response, generate a new detecting response and return the detecting response to the source client.

Furthermore, the above detecting request may further include the source client identity and the detecting response can further include the destination client identity. In that case, the server is adapted to forward the detecting request received from the source client to the destination client and forward the detecting response received from the destination client to the source client.

In addition, the server may further adapted to return a receiving response to the source client after it receives the detecting request from the source client.

In the case that communication time is included in the condition of network communication, the above detecting request further includes a TimeStamp recording the system time t1; and the server is adapted to obtain the TimeStamp carried in the received detecting request and then return a response carrying the TimeStamp to the source client.

Moreover, the above detecting request may further include a SequenceID. In that case, the server is adapted to receive the detecting request from a source client, obtain the SequenceID carried in the detecting request and return a receiving response carrying the SequenceID to the source client.

The method and corresponding server for detecting the condition of network communication according to an embodiment of the invention are described above; next, a method and a server for detecting the condition of network communication according to another embodiment of the invention will be described.

The other method for detecting the condition of network communication provided in the present invention is as follows: the server obtains and stores information on the condition of network communication between the server and each of the clients actively; when receiving a detecting request from a source client to obtain the condition of network communication between the source client and the destination client, the server obtains the information, which is stored in the server, on the condition of network communication between the server and the corresponding destination client, and then returns a detecting response to the source client according to the corresponding information on condition of network communication; the source client obtains the condition of network communication between the source client and the destination client according to the received detecting response. It can be seen from the above process that the server actively obtains the condition of network communication between the server and the destination client before it receives the detecting request from the source client. Therefore, the method belongs to a proactive method for obtaining the condition of network communication.

In another embodiment of the present invention, a server is adapted to obtain and store condition of network communication between the server and each of the clients, and receive a detecting request from a source client, obtain information, which is stored in the server, on the condition of network communication between the server and the corresponding destination client, and then return a detecting response to the source client according to the obtained information on condition of network communication.

The server will be described in detail as follows.

In a preferred embodiment of the invention, the above server is adapted to obtain the destination client identity carried in the received detecting request and search for the condition of network communication corresponding to the destination client identity stored in the server.

In another preferred embodiment, the above server is adapted to store route information of all clients in advance, and then send a detecting request to each of the clients in a preset interval according to the route information stored in the server, and obtain the condition of network communication between the server and the corresponding client according to the detecting response returned from the client.

In another preferred embodiment, the above server is further adapted to obtain and store the communication time between the server and each of the clients, search for the stored communication time T1 between the server and the destination client corresponding to the destination client identity carried in the detecting request and the communication time T2 between the server and the source client, and include the communication times T1 and T2 in the detecting response returned to the source client.

In further another preferred embodiment, the above server is further adapted to obtain and store the communication time between the server and each of the clients, search for the stored communication time T1 between the server and the destination client corresponding to the destination client identity carried in the detecting request and the communication time T2 between the server and the source client, and calculate the sum of communication times T1 and T2 found by the server; then including the calculation result in the detecting response returned to the source client.

In addition, the above server is adapted to store route information of all clients in advance, and then send a detecting request to each of the clients in a preset interval according to the route information stored in the server, and include, in the detecting request, the system time t1 at which the detecting request is sent. When receiving a detecting response carrying the system time t1 from the client, the server records the system time t2 at which the detecting response is received, and obtains the system time t1 from the received detecting response. Then, the server calculates the difference between system time t2 and system time t1 to obtain the communication time between the server and the corresponding client; or,

the above server is adapted to store the system time t1 at which the detecting request is sent and then record the system time t2 at which the detecting response is received after receiving the detecting response carrying the system time t1 returned from the client, and obtain the system time t1 from the detecting response; and then, the server calculates the difference between system time t2 and system time t1 to obtain the communication time between the server and the corresponding client.

The first method for detecting condition of network communication according to the present invention (i.e., the passive method for detecting condition of network communication) will be described in detail in embodiments 1-4. In embodiments 1-4, the server stores route information of the clients in advance. The route information mainly includes a communication address of the client, such as the Internet Protocol (IP) address. Now, the processes for detecting condition of network communication in the four embodiments will be described in detail respectively.

### Embodiment 1

In this embodiment, the following method is taken for transmitting messages, that is, the source client sends a detecting request in which a destination client identity (descUseridentity) is contained, and then the server replaces the destination client identity carried in the received detecting request by the source client identity (srcUseridentity), so that the source client can obtain the condition of network connection between the source client and the destination client finally. The detecting process in this embodiment is shown in FIG. 2, and it includes the following processes.

Process 201: The source client sends a detecting request containing the destination client identity to the server.

The client identity is a unique identity for a client, such as User1 or User2.

Process 202: After receiving the detecting request, the server obtains the destination client identity User2 from the detecting request, and then searches for the route information corresponding to the destination client identity User2 stored in the server, replaces the destination client identity User2 carried in the original detecting request by the source client identity User1 of the source client that sent the detecting request, generates a new detecting request containing the source client identity User1, and sends the detecting request to the destination client.

Process 203: After receiving the detecting request, the destination client obtains the source client identity User1 carried in the detecting request, and then generates a detecting response containing the source client identity User1 and sends the detecting response to the server.

Process 204: After receiving the detecting response, the server obtains route information of the source client, which is stored in the server, according to the source client identity User1 contained in the request, replaces the source client identity User1 in the received detecting response by the destination client identity User2 of the destination client that sent the detecting response, and then generates a new detecting response containing the destination client identity User2, and returns the detecting response to the source client according to the obtained route information.

Process 205: After receiving the detecting response, the source client obtains the destination client identity User2 from the detecting response, and obtains the condition of network communication between the source client and the destination client.

The case that the source client obtains the condition of network communication between the source client and the corresponding destination client means: after receiving the detecting response returned from the server, the source client obtains the destination client identity carried in the response, and determines that the network between the source client and the destination client is in “Connected” state.

In the above embodiment, the server performs conversion for the client identity contained in the received detecting request, so that the detecting request and the detecting response can be transmitted between the source client and the destination client. In that way, the object of enabling the source client to obtain the condition of network connection between the source client and the destination client is achieved. In the present invention, a method in which the source client includes both its identity and the destination client identity in the detecting request to be sent may be taken, so that the conversion, which is performed by the server, for the client identity carried in the message is avoided. This method will be described in embodiment 2 in detail.

### Embodiment 2

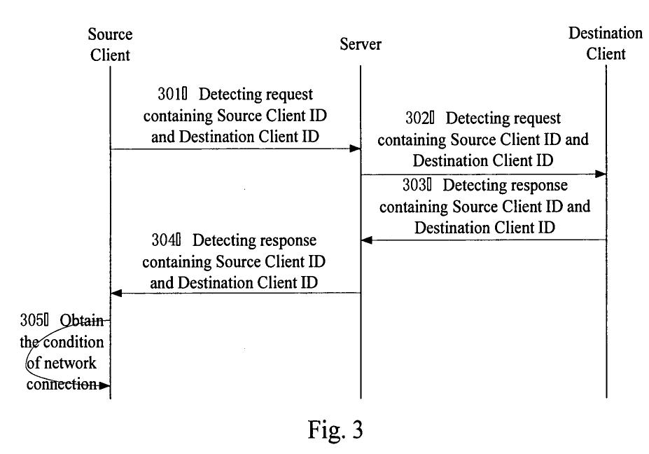

The detecting process of this embodiment is shown in FIG. 3, and it includes the following processes.

Process 301: The source client sends a detecting request carrying its identity User1 and the destination client identity User2 to the server.

Process 302: After receiving the detecting request, the server parses the detecting request to obtain the destination client identity User2 from the detecting request, and then searches for route information corresponding to the destination client identity User2 from the client route information stored in the server. Then, the server sends the received detecting request to the destination client according to the obtained route information.

Process 303: After receiving the detecting request, the destination client parses the detecting request to obtain the source client identity User1 and the destination client identity User2, from the detecting request, generates a detecting response containing the source client identity User1 and destination client identity User2, and sends the detecting response to the server.

Process 304: The server parses the received detecting response to obtain the source client identity User1 from the detecting response, and then searches for route information corresponding to the source client identity User1 from the client route information stored in the server. Finally, the server returns the received detecting response to the source client according to the obtained route information.

Process 305: After receiving the detecting response, the source client obtains the destination client identity User2 from the detecting response, and obtains the condition of network communication between the source client and the destination client, that is, the source client determines the network between the source client and the corresponding destination client is in “Connected” state.

Two methods for detecting condition of network connection, i.e., whether the network between a client and the opposite client is in connection, are described in above two embodiments, respectively. In addition, the present invention can further detect the communication time between the source client and the destination client. The two methods will be described in detail in embodiment 3 and embodiment 4.

### Embodiment 3

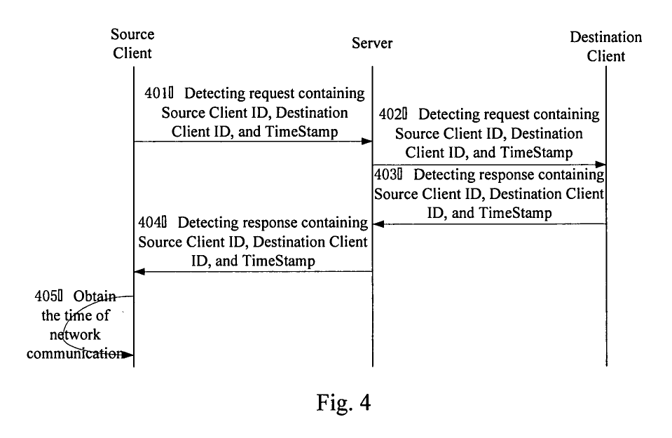

In this embodiment, the source client includes, in a detecting request to be sent, a system time at which the detecting request is sent; the destination client transfers this system time from the received detecting request to a detecting response, and returns the detecting response to the source client, so that the source client can calculate the difference between the system time at which the detecting response is received and the system time at which the detecting request that is carried in the detecting response is sent, and thereby obtains the communication time between the source client and the destination client. The detecting process of this embodiment is shown in FIG. 4, and it includes the following processes.

Process 401: First, the source client obtains its current system time (SystemTime), e.g., t1; then, it generates a detecting request carrying the source client identity User1, the destination client identity User2, and a TimeStamp that records the obtained system time t1, and sends the detecting request to the server.

Process 402 is identical to the above process 302, and therefore will not be described further here.

Process 403: After receiving the detecting request, the destination client obtains the source client identity User1, the destination client identity User2 and the TimeStamp from the detecting request, and then generates a detecting response, includes the source client identity User1, the destination client identity User2 and the TimeStamp obtained by parsing in the detecting response, and finally returns the detecting response to the server.

Process 404 is identical to the above process 304.

Process 405: When receiving the detecting response, the source client obtains the system time t2 at which the detecting response is received, obtains the TimeStamp contained in the received detecting response, and then calculates the difference between the system time t2 and the system time t1 recorded in the TimeStamp. Then the source client obtains the communication time between the source client and the destination client.

In the above embodiment 3, the object of obtaining, by the source client, the communication time between the source client and the destination client is achieved by calculating the difference between the system time at which the detecting response is received and the system time at which the detecting request is sent. Alternatively, the above time difference can also be obtained in the present invention by taking another method, that is, the source client records the system time at which the detecting request is sent and the system time at which the corresponding detecting response is received, and then calculates the difference of the two times, so as to obtain the communication time between the source client and the destination client. This method will be described in detail in embodiment 4 of the present invention.

### Embodiment 4

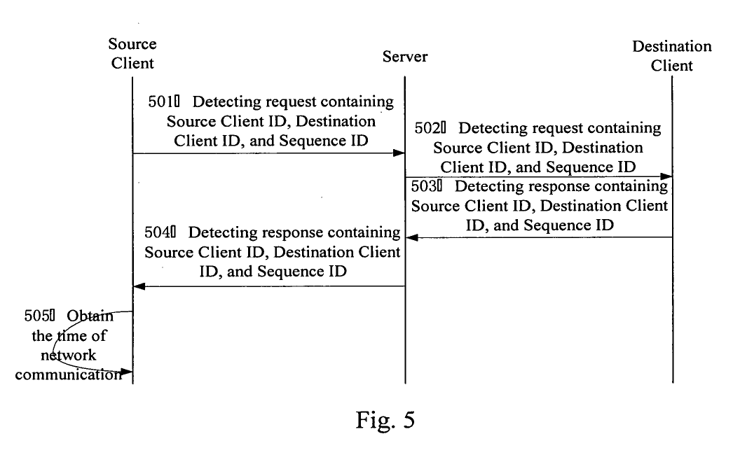

The detecting process in this embodiment is shown in FIG. 5, and it includes the following processes.

Process 501: The source client sends a detecting request carrying the source client identity User1, the destination client identity User2 and a sequence identification (SequenceID) that uniquely identifies the detecting request to the server, and stores, in the source client, the SequenceID and the system time t1 at which the detecting request is sent, and makes the SequenceID and the system time t1 correspond to each other.

Because the source client has to match the detecting request to the received detecting response, in this embodiment, the source client further needs to include a sequence identification in the detecting request.

Process 502 is identical to the above process 302, that is, after receiving the detecting request, the server parses the detecting request to obtain the destination client identity User2 from the detecting request, and then searches for route information corresponding to the destination client identity User2 from the client route information stored in the server. Then, the server sends the received detecting request to the destination client according to the obtained route information.

Process 503: After receiving the detecting request from the server, the destination client parses the detecting request to obtain the source client identity User1, the destination client identity User2 and the SequenceID, and then generates a detecting response carrying the source client identity User1, the destination client identity User2 and the SequenceID, and finally sends the detecting response to the server.

Process 504 is identical to the above process 304, that is, the server parses the received detecting response to obtain the source client identity User1 from the detecting response, and then searches for route information corresponding to the source client identity User1 from the client route information stored in the server. Finally, the server returns the received detecting response to the source client according to the obtained route information.

Process 505: when receiving the detecting response returned from the server, the source client records the system time t2 at which the detecting response is received and obtains the SequenceID carried in the received detecting response. Subsequently, the source client searches for the system time t1 corresponding to the SequenceID. And finally, the source client calculates the difference between the system time t2 at which the detecting response is received and the system time t1 at which the detecting request is sent, and the result that is obtained by calculating is the communication time between the source client and the destination client.

In this embodiment, a method in which a SequenceID is carried in the detecting request and the SequenceID is stored in the source client is taken, the detecting request message can be matched to the detecting response message at the source client. However, the present invention is not limited to this; other methods can also be taken to implement the message matching.

In the above embodiment 3 and embodiment 4, the communication time is obtained on the basis of including both the source client identity and the destination client identity in the detecting request, as described in embodiment 2. In the present invention, the system time t1 at which the detecting request is sent and the system time t2 at which the detecting response is received can also be obtained by only including the destination client identity in the detecting request, as described in embodiment 1, and then the method described in embodiment 3 or embodiment 4 may be taken to calculate the time difference, therefore the communication time between the source client and the destination client can be obtained finally. Because the implementation is basically identical to the process described in embodiment 3 or embodiment 4, it will not be described further here.

Some preferred embodiments of the present invention for enabling a source client to detect the condition of network connection and obtain the communication time between the source client and a destination client are described as above. In addition, on the basis of detecting the condition of network communication between a source client and a destination client as described above, the present invention can also be adapted to further detect the condition of network connection and the communication time between the source client and the server. The method for obtaining the condition of network connection between the source client and the server will be described in the case that both the source client identity and the destination client identity are carried in the detecting request, as described in above embodiment 2, and the method for detecting the communication time between the source client and the server will be described based on embodiment 3.

First, the condition of network connection between the source client and the server is obtained as follows.

In this case, the forementioned process 302 is required to further include the following process. That is, after receiving the detecting request from the source client, the server returns a receiving response (RecvResp) to the source client, and the source client obtains the condition of network connection between the source client and the server according to the RecvResp.

The source client obtaining the condition of network connection between the source client and the server according to the receiving response may be implemented as follows: the source client determines whether the network between the source client and the server is in “Connected” state based on whether a receiving response is received from the server, i.e., if a receiving response is received from the server, the source client will determine that the network between the source client and the server is in “Connected” state; and if no receiving response is received from the server, the source client will determine that the network between the source client and the server is in “Disconnected” state.

The above method for obtaining the condition of network connection between the source client and the server is also applicable to other embodiments, and therefore will not be described further here.

The method for detecting the communication time between the source client and the server will be described on the basis of embodiment 3.

In the method, the forementioned process 402 further includes the following process. That is, after receiving a detecting request from the source client, the server parses the detecting request to obtain the source client identity User1, the destination client identity User2 and the TimeStamp from the detecting request and generates a receiving response carrying the source client identity User1, the destination client identity User2 and the TimeStamp, and then sends the receiving response to the source client. When receiving the receiving response, the source client records the system time t3 at which the receiving response is received, obtains the SequenceID from the received detecting response, and then searches for the stored system time t1 corresponding to the SequenceID; finally, the source client calculates the difference between the system time t3 at which the receiving response is received and the system time t1 at which the detecting request is sent. The result obtained by calculating is the communication time between the source client and the server.

Of course, in the present invention, the communication time between the source client and the server can also be obtained by using the method described in embodiment 4.

Specifically, the following process is further included in the process 502 of the forementioned embodiment 4. That is, when receiving a detecting request from the source client, the server parses the detecting request to obtain the SequenceID from the detecting request, generates a receiving response carrying the SequenceID, and then sends the receiving response to the source client. The source client records its system time t3 at which the receiving response is received, obtains the SequenceID from the receiving response, and then searches for the stored system time t1 corresponding to the SequenceID. Then the source client calculates the difference between system time t3 at which the receiving response is received and system time t1 at which the detecting request is sent to obtain the communication time between the source client and the server.

The above two methods for obtaining the communication time from the source client to the server are also applicable to other embodiments, and the processes are basically identical; therefore, it will not be described further here.

A method for detecting the condition of network communication according to the present invention is described in embodiments 1-4 as above. Another method for detecting the condition of network communication according to the present invention will be described in detail. Please see embodiment 5.

### Embodiment 5

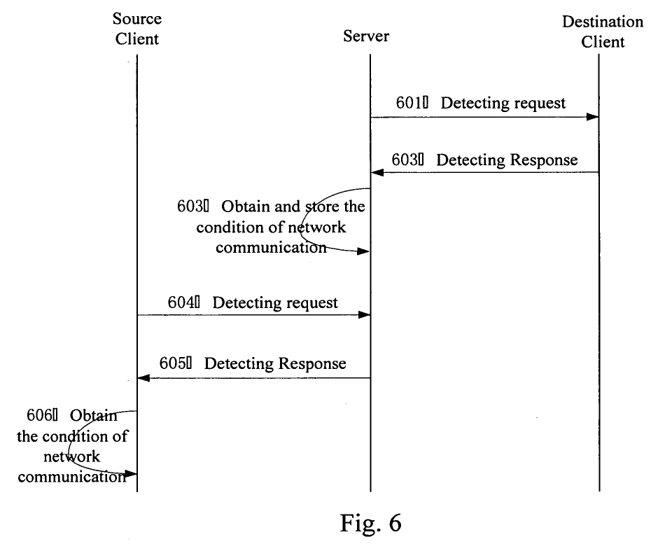

In this embodiment, it is also needed to store route information of all clients in the server in advance, as described above. The procedure for detecting the condition of network communication in this embodiment is shown in FIG. 6, and it includes the following processes.

Process 601: The server sends in advance a detecting request to each of the destination clients in a preset interval according to the route information of the client stored in the server.

In this process, the server needs to obtain the information on condition of network communication between the server and all clients in the network, therefore, on one aspect, for the server, all clients in the network are destination clients. On the other aspect, in order to keep consistent with the forementioned embodiments, the clients to which the server sends the detecting request in advance will be referred to as “destination clients”.

Process 602: After receiving the detecting request from the server, the destination client returns a detecting response to the server.

Process 603: The server obtains and stores the information on the condition of network communication between the server and the corresponding destination client according to the received detecting response.

The process in which the server obtains the condition of network communication between the server and each of the clients is described in above process 601-603, and in the above processes, the server sends a detecting request to each client, and then obtains the condition of network communication between the server and the corresponding client according to the detecting response returned from the client. Alternatively, the following method can also be used in the present invention, that is, the server sends a Ping signaling to each client according to the stored IP address of each client. In addition, when a client disconnects from the server, the server will delete the stored IP address of the client.

Process 604: The source client sends a detecting request carrying the destination client identity User2 to the server.

Process 605: After receiving the detecting request from the source client, the server searches for the stored information on the condition of network communication between the server and the destination client corresponding to the destination client identity User2, and then returns a detecting response carrying the corresponding destination client identity User2 to the source client, according to the obtained information on the condition of network communication.

Process 606: The source client obtains the condition of network communication between the source client and the destination client according to the received detecting response.

In this embodiment, the condition of network connection also includes: state of network connection; or, communication time if the network is in “Connected” state.

First, for the condition of network connection, in the process 605, the procedure of returning a detecting response to the source client according to the obtained condition of network communication is as follows. The server obtains the condition of network communication between the server and the corresponding destination client firstly, and determines whether the network between the server and the destination client is in “Connected” state. If the network is in “Connected” state, the server will return a detecting response indicating the network between the server and the corresponding destination client is in “Connected” state to the source client; otherwise, the server will return a detecting response indicating the network between the server and the corresponding destination client is in “Disconnected” state to the source client, and at the same time, includes the destination client identity in the detecting response. In the process 606, after receiving the detecting response, the source client determines that the network between the source client and the destination client is in “Connected” state if it is determined, according to the condition of network communication carried in the response, that the network between the server and the destination client is in “Connected” state.

In addition, if the condition of network communication further includes the communication time on the premise that the network is in “Connected” state, in embodiment 5, the server needs to obtain and store, in a preset interval, the communication time between the server and each client. In the process 605, the procedure in which the server searches for the condition of network communication further includes the following process. That is, the server searches for the stored communication time T1 between the server and the destination client corresponding to the destination client identity User2 carried in the detecting request and the communication time T2 between the server and the source client; furthermore, the server includes the communication time T1 and the communication time T2 in the detecting response to the source client. Moreover, the process 606 further includes the following process. That is, after receiving the detecting response, the source client calculates the sum of the communication time T1 and the communication time T2, and thereby obtains the communication time between the source client and the corresponding destination client.

In addition, in the above process 605, after the server finds the stored communication time T1 between the server and the destination client corresponding to the destination client identity carried in the detecting request and the communication time T2 between the server and the source client, the following process can also be implement. That is, the server further calculates the sum of the communication time T1 and the communication time T2 and includes the result directly in the detecting response returned to the source client. In that way, in the above process 606, the source client can obtain the communication time between the source client and the destination client simply by obtaining the sum of the communication time T1 and the communication time T2 from the received detecting response. As the result, the burden on the source client can be alleviated.

Furthermore, the communication time can also be obtained with the method described in embodiment 3 or embodiment 4 of the present invention. That is to say, with the method described in embodiment 3, the system time t1 at which a detecting request is sent is carried in the detecting request sent from the server to each client; when receiving a detecting response carrying the system time t1 from the client, the server records the system time t2 at which the detecting response is received, obtains the system time t1 from the received detecting response, and then calculates the difference between system time t2 and system time t1 to obtain the communication time between the server and the corresponding client. Or, the method described in embodiment 4 can also be taken, i.e., the server stores the system time t1 at which the detecting request is sent; when receiving a detecting response carrying the system time t1 from a destination client, the server records the system time t2 at which the detecting response is received, obtains the system time t1 from the received detecting response, and then calculates the difference between system time t2 and system time t1 to obtain the communication time between the server and the corresponding client. Of course, the system time can be carried in the detecting request or the detecting response by means of the TimeStamp as described above. If the latter method is used to obtain the time difference, the issue of matching of the detecting request with the detecting response also needs to be considered. In that case, the processes described in embodiment 4 can be used, i.e., the SequenceID is carried in the detecting request to be sent, and the SequenceID and the system time at which the detecting request is sent are stored, so as to realize, in the source client, the matching of the sent detecting request with the received detecting response finally.

The methods for detecting, by the client, the condition of network communication according to the present invention are described as above. The methods provided in the present invention are applicable to any network consisting of a server and more than one client connected to the server, such as an online gaming system.

Anyhow, the present invention has been illustrated and described with reference to some preferred embodiments which do not intent to limit the protective scope of the present invention.

1. A method for detecting condition of network communication, comprising:
receiving a detecting request for obtaining the condition of network communication between a source client and a destination client;
sending the detecting request to the destination client according to route information of the destination client after receiving the detecting request, and receiving a detecting response returned from the destination client;
returning the detecting response to the source client according to route information of the source client after the server receives the detecting response.

2. The method according to claim 1, wherein, in process of receiving the detecting request for obtaining the condition of network communication between the source client and a destination client, the detecting request carries a destination client identity;
and the process of sending the detecting request to the destination client according to route information of the destination client after receiving the detecting request and receiving the detecting response returned from the destination client further comprises: obtaining the destination client identity from the received detecting request, and searching for the route information corresponding to the destination client identity in the route information of clients, and then sending the detecting request to the destination client;
and in the process of sending the detecting request to the destination client according to route information of the destination client after receiving the detecting request and receiving the detecting response returned from the destination client, the detecting response carries an identity of source client that initiates the detecting request to the server;
and the process of returning the detecting response to the source client according to route information of the source client after the server receives the detecting response further comprises: obtaining the source client identity carried in the received detecting response, and searching for the route information corresponding to the source client identity from the client route information, and returning the detecting response to the source client.

3. The method according to claim 2, wherein, in process of sending the detecting request to the destination client according to route information of the destination client after receiving the detecting request and receiving the detecting response returned from the destination client, the procedure that the server sends the detecting request to the destination client comprises: replacing the destination client identity in the received detecting request by the identity of the source client that sends the detecting request, generating a new detecting request and sending the request to the destination client; and the detecting response is obtained by means of obtaining the source client identity carried in the detecting request, generating the detecting response containing the source client identity and returning the detecting response to the server;
and in process of returning the detecting response to the source client according to route information of the source client after the server receives the detecting response, the procedure that the server returns the detecting response to the source client comprises: replacing the source client identity in the received detecting response by the identity of destination client that sent the response, generating a new detecting response and returning the detecting response to the source client;
and detecting the method further comprises: when receiving the detecting response returned from the server, obtaining the destination client identity carried in the response, and determining that the network between the source client and the destination client is still in “Connected” state.

4. The method according to claim 2, wherein, in process of receiving the detecting request for obtaining the condition of network communication between the source client and the destination client, the detecting request further contains the source client identity;
and in process of sending the detecting request to the destination client according to route information of the destination client after receiving the detecting request and receiving the detecting response returned from the destination client, the procedure that the server sends the detecting request to the destination client comprises: forwarding the detecting request received from the source client to the destination client; and the detecting response is obtained by means of obtaining the source client identity and the destination client identity from the received detecting request, generating a detecting response containing the source client identity and the destination client identity and returning the detecting response to the server;
and in process of returning the detecting response to the source client according to route information of the source client after the server receives the detecting response, the procedure that the server returns the detecting response to the source client comprises: forwarding the detecting response received from the destination client to the source client; and the method further comprises: obtaining the destination client identity carried in the detecting response, and determining the network between the source client and the destination client is still in “Connected” state when receiving the detecting response returned from the server.

5. The method according to any one of claims 1, wherein the detecting request further comprises a TimeStamp recording a system time t1 at which the detecting request is sent to the server;
and in process of sending the detecting request to the destination client according to route information of the destination client after receiving the detecting request and receiving the detecting response returned from the destination client, the detecting response further comprises the TimeStamp obtained by the destination client;
and the method further comprises: recording a system time t2 at which the detecting response is received, obtaining the system time t1 recorded in the TimeStamp from the received detecting response, and calculating the difference between the system time t2 and the system time t1 to obtain a communication time between the source client and the corresponding destination client.

6. The method according to claim 1, wherein, in process of receiving the detecting request for obtaining the condition of network communication between the source client and the destination client, the detecting request further comprises a SequenceID of this detecting request; and the method further comprises: obtaining the system time t1 at which the detecting request is sent to the server, and storing the SequenceID of the detecting request together with the system time t1 in a corresponding way;
and in process of sending the detecting request to the destination client according to route information of the destination client after receiving the detecting request and receiving the detecting response returned from the destination client, the detecting response is received by means of obtaining the SequenceID from the received detecting request, and including the SequenceID in the detecting response sent to the server;
and the method further comprises: when receiving the detecting response returned from the server, recording the system time t2 at which the detecting response is received, obtaining the SequenceID carried in the response, searching for the system time t1 stored in the source client corresponding to this SequenceID, and calculating the difference between system time t2 and system time t1 to obtain the communication time between the source client and the corresponding destination client.

7. The method according to of claim 1, wherein the process of sending the detecting request to the destination client according to route information of the destination client after receiving the detecting request and receiving the detecting response returned from the destination client further comprises: returning a receiving response to the source client, when the server receives the detecting request from the source client.

8. The method according to claim 7, further comprising: determining that the network between the source client and the server is in “Connected” state when receiving the receiving response returned from the server.

9. The method according to claim 5, wherein the TimeStamp is used to record the system time t1.

10. The method according to claim 7, further comprising: obtaining the system time t1 at which the detecting request is sent to the server, and the detecting request further includes a TimeStamp recording the system time t1;
and in process of sending the detecting request to the destination client according to route information of the destination client after receiving the detecting request and receiving the detecting response returned from the destination client, the procedure that the server returns a receiving response to the source client comprises: obtaining the TimeStamp carried in the received detecting request, and then returning the receiving response carrying the TimeStamp to the source client; and the method further comprises: obtaining a system time t3 at which the receiving response is received, obtaining the system time t1 recorded in the TimeStamp from the received receiving response, and calculating a difference between system time t3 and system time t1 to obtain the communication time between the source client and the server.

11. The method according to claim 7, wherein, in process of receiving the detecting request for obtaining the condition of network communication between the source client and the destination client, the detecting request further comprises the SequenceID of the detecting request; and the method further comprises: obtaining a system time t1 at which the detecting request is sent to the server, and storing the SequenceID of the detecting request together with the system time t1 in a corresponding way;
and the process of sending the detecting request to the destination client according to route information of the destination client after receiving the detecting request and receiving the detecting response returned from the destination client further comprises: after receiving the detecting request from the source client, obtaining the SequenceID carried in the detecting request, and then returning the receiving response carrying the SequenceID to the source client; and the method further comprises: recording the system time t3 at which the receiving response is received, obtaining the SequenceID carried in the received receiving response, and searching for the system time t1 stored in the source client corresponding to the SequenceID, and then calculating the difference between system time t3 and system time t1 to obtain the communication time between the source and the server.

12. The method according to claim 1, further comprising: obtaining the condition of network communication between the source client and the destination client according to the received detecting response.

13. A server, which is connected to more than one client, wherein the server is adapted to receive a detecting request from a source client for obtaining condition of network communication between the source client and a destination client, send a detecting request to the destination client according to route information of the destination client, receive a detecting response returned from the destination client, and return a detecting response to the source client according to route information of the source client.

14. The server according to claim 13, wherein the detecting request carries a destination client identity and the detecting response carries a source client identity;
and the server is adapted to obtain the destination client identity carried in the received detecting request and search for the route information corresponding to the destination client identity in the client route information; and the server is further adapted to obtain the source client identity carried in the received detecting response and search for the route information corresponding to the source client identity in the client route information.

15. The server according to claim 14, wherein the server is adapted to replace the destination client identity in the received detecting request by the identity of the source client that sends this detecting request, generate a new detecting request and send the detecting request to the destination client; and the server is further adapted to replace the source client identity in the received detecting response by the identity of the destination client that sends this detecting response, and generate a new detecting response and return the new detecting response to the source client.

16. The server according to claim 14, wherein, the detecting request further comprises the source client identity and the detecting response further comprises the destination client identity;
and the server is adapted to forward the detecting request received from the source client to the destination client and forward the detecting response received from the destination client to the source client.

17. The server according to claim 13, wherein the server is further adapted to return a receiving response to the source client when it receives the detecting request from the source client.

18. The server according to claim 17, wherein, the detecting request further comprises a TimeStamp that records the system time t1;
and the server is adapted to obtain the TimeStamp carried in the received detecting request, and return the receiving response carrying the TimeStamp to the source client.

19. The server according to claim 17, wherein, the detecting request further comprises a SequenceID;
and the server is adapted to receive the detecting request from the source client, obtain the SequenceID carried in the detecting request, and return the response carrying the SequenceID to the source client.

20. A method for detecting condition of network communication, wherein the network at least comprises a server and more than one client connected to the server, comprising:
receiving a detecting request for obtaining the condition of network communication between the source client and a destination client;
obtaining the condition of network communication between the server and the corresponding destination client after receiving the detecting request from the source client; and returning a detecting response to the source client according to the obtained condition of network communication to the source client.

21. The method according to claim 20, wherein the detecting request carries a destination client identity;
and in process of obtaining the condition of network communication between the server and the corresponding destination client after receiving the detecting request from the source client and returning the detecting response to the source client according to the obtained condition of network communication to the source client, the condition of network communication between the server and the destination client is obtained by means of obtaining the destination client identity carried in the received detecting request, and then searching for the condition of network communication corresponding to the destination client identity.

22. The method according to claim 20, wherein the way of obtaining the condition of network communication between the server and each of the clients comprises: sending the detecting request to each of the clients in a preset interval according to the route information, and obtaining the condition of network communication between the server and the corresponding client according to the detecting response returned from the client.

23. The method according to claim 20, wherein, in process of obtaining the condition of network communication between the server and the corresponding destination client after receiving the detecting request from the source client and returning the detecting response to the source client according to the obtained condition of network communication to the source client, the procedure of returning the detecting response to the source client comprises: directly returning the detecting response containing the condition of network communication between the server and the corresponding destination client to the source client;
and the method further comprises: determining that the network between the source client and the destination client is in “Connected” state after receiving the detecting response and determining, according to the condition of network communication carried in the response, that the network between the server and the destination client is in “Connected” state; otherwise determining that the network between the source and the destination client is in “Disconnected” state.

24. The method according to claim 20, wherein the procedure of obtaining and storing the condition of network communication between the server and each of the clients further comprises: obtaining and storing a communication time between the server and each of the clients;
and in process of obtaining the condition of network communication between the server and the corresponding destination client after receiving the detecting request from the source client and returning the detecting response to the source client according to the obtained condition of network communication to the source client, the procedure of obtaining the condition of network communication further comprises: searching for a stored communication time T1 between the server and the client that corresponds to the destination client identity carried in the detecting request and a communication time T2 between the server and the source client; and the procedure of returning the detecting response to the source client further comprises: including the communication times T1 and T2 in the detecting response returned to the source client;
and the method further comprises: calculating the sum of the communication times T1 and T2 to obtain the communication time between the source client and the destination client, when the source client receives the detecting response.

25. The method according to claim 20, wherein the procedure of obtaining and storing the condition of network communication between the server and each of the clients further comprises: obtaining and storing the communication time between the server and each of the clients;
and in process of obtaining the condition of network communication between the server and the corresponding destination client after receiving the detecting request from the source client and returning the detecting response to the source client according to the obtained condition of network communication to the source client, the procedure of obtaining the condition of network communication further comprises: searching for the stored communication time T1 between the server and the client that corresponds to the destination client identity carried in the detecting request and the communication time T2 between the server and the source client, and calculating the sum of communication times T1 and T2 found by the server; then including the calculation result in the detecting response returned to the source client;
and the method further comprises: obtaining the calculation result from the received detecting response to obtain the communication time between the source client and the destination client.

26. The method according to claim 24, wherein the way of obtaining the communication time between the server and each of the clients comprises: sending a detecting request to each of the clients in a preset interval according to the route information, and including in the detecting request, the system time t1 at which the detecting request is sent; when receiving a detecting response carrying the system time t1 from the client, recording the system time t2 at which the detecting response is received, and obtaining the system time t1 from the received detecting response; then, calculating the difference between system time t2 and system time t1 to obtain the communication time between the server and the corresponding client; or,
storing the system time t1 at which the detecting request is sent and then recording the system time t2 at which the detecting response is received after receiving the detecting response carrying the system time t1 returned from the client, and obtaining the system time t1 from the detecting response; then, calculating the difference between system time t2 and system time t1 to obtain the communication time between the server and the corresponding client.

27. A server, adapted to obtain and store condition of network communication between the server and each of clients, and receive a detecting request from a source client, obtain the condition of network communication between the server and a corresponding destination client, and return a detecting response to the source client according to the obtained condition of network communication.

28. The server according to claim 27, wherein, the server is adapted to obtain a destination client identity carried in the received detecting request, and search for the condition of network communication corresponding to the destination client identity.

29. The server according to claim 27, wherein, the server is adapted to store route information of all clients in advance, and then send the detecting request to each of the clients in a preset interval according to the route information, and obtain the condition of network communication between the server and the corresponding client according to the detecting response returned from the client.

30. The server according to claim 27, wherein, the server is further adapted to obtain and store a communication time between the server and each of the clients, search for a stored communication time T1 between the server and the client corresponding to the destination client identity carried in the detecting request and a communication time T2 between the server and the source client, and include the communication times T1 and T2 in the detecting response returned to the source client.

31. The server according to claim 27, wherein, the server is further adapted to obtain and store the communication time between the server and each of the clients, search for the stored communication time T1 between the server and the client corresponding to the destination client identity carried in the detecting request and the communication time T2 between the server and the source client, and calculate the sum of communication times T1 and T2, and then include the calculation result in the detecting response returned to the source client.

32. The server according to claim 30, wherein, the server is adapted to store the route information of all clients in advance, and then send the detecting request to each of the clients in a preset interval according to the route information, and include, in the detecting request, a system time t1 at which the detecting request is sent; when receiving a detecting response carrying the system time t1 from the client, the server records a system time t2 at which the detecting response is received, and obtains the system time t1 from the received detecting response; then, the server calculates the difference between system time t2 and system time t1 to obtain the communication time between the server and the corresponding client; or
the server is adapted to store the system time t1 at which the detecting request is sent and then records the system time t2 at which the detecting response is received after receiving the detecting response carrying the system time t1 returned from the client, and obtain the system time t1 from the detecting response; then, the server calculates the difference between system time t2 and system time t1 to obtain the communication time between the server and the corresponding client.
